(19) United States
(12) Patent Application Publication
(10) Pub. No.: US 2003/0219117 A1
(43) Pub. Date: Nov. 27, 2003

(54) Device for fastening body of cellular phone or PDA to its base

(76) Inventor: Huei-Hsin Sun, Taipei City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/153,541

(22) Filed: May 22, 2002

(51) Int. Cl. H04M 1/00; H04M 9/00

(52) U.S. Cl. 379/441; 379/428.01

(57) ABSTRACT

An intermediate arrangement for fastening a body of a portable communication device such as cellular phone or PDA to its base is provided. The body includes a lower peripheral flange, the base includes an upper peripheral flange, and the arrangement is shaped like a closed loop with a substantially T-shaped cross-section. The arrangement comprises an upper peripheral groove and a lower peripheral groove wherein the lower peripheral flange is aligned with the upper peripheral groove and the upper peripheral flange is aligned with the lower peripheral groove respectively prior to threadedly securing the base, the arrangement, and the body together.

### FIELD OF THE INVENTION

The present invention relates to fastening devices and more particularly to an improved device for fastening body of a cellular phone or PDA (Personal Digital Assistant) to its base.

### BACKGROUND OF THE INVENTION

Conventionally, arrangement for fastening body of a cellular phone or PDA to its base comprises a plurality of spaced apart tabs in the base and a corresponding number of slots in the body for receiving and snappingly securing to the tabs. However, the prior art suffered from a disadvantage. For example, the plastic tabs tend to deform or even break after a period time of use. As a result, the fastening function of the tabs and the slots is compromised. Thus improvement exists.

### SUMMARY OF THE INVENTION

It is therefore an object of the present invention to provide an intermediate arrangement for fastening a body of a portable communication device such as cellular phone or PDA to its base wherein the body includes a lower peripheral flange, the base includes an upper peripheral flange, the arrangement is shaped like a closed loop with a substantially T-shaped cross-section, the arrangement comprising an upper peripheral groove and a lower peripheral groove wherein the lower peripheral flange is aligned with the upper peripheral groove and the upper peripheral flange is aligned with the lower peripheral groove respectively prior to threadedly securing the base, the arrangement, and the body together.

The above and other objects, features and advantages of the present invention will become apparent from the following detailed description taken with the accompanying drawings.

### BRIEF DESCRIPTION OF THE DRAWINGS

FIG. 1 is a perspective view showing a body of cellular phone fastened to base thereof by a device according to the invention;

FIG. 2 is a perspective view of a portion of the fastening device;

FIG. 3 is a top plan view of the cellular phone;

FIG. 4 is a side view showing how to secure the base, the body, and the fastening device together;

FIG. 5 is a top plan view of a PDA assembled by the fastening device of the invention; and

FIG. 6 is a side view of FIG. 5.

### DETAILED DESCRIPTION OF THE PREFERRED EMBODIMENTS

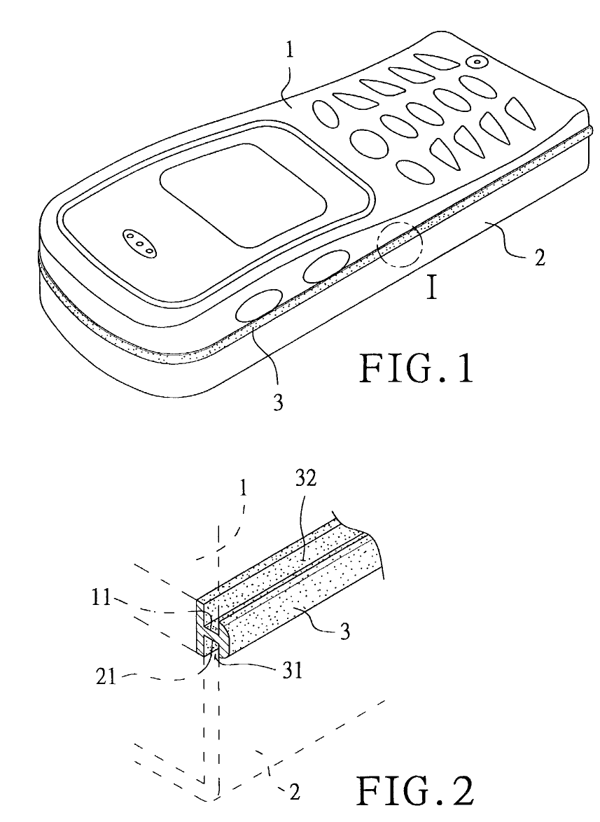

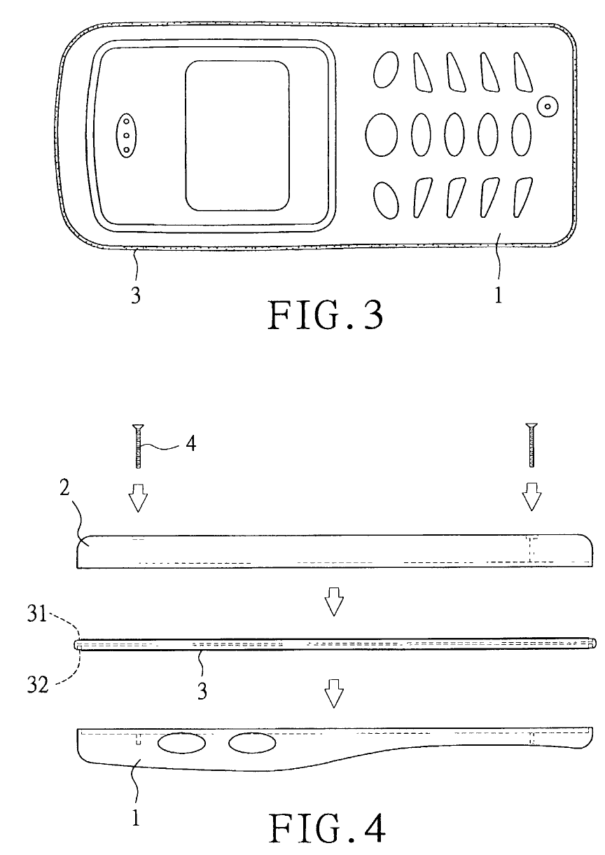

Referring to FIGS. 1 to 4, there is shown an intermediate device 3 for fastening body 1 of a portable communication device (e.g., cellular phone) to its base 2 in accordance with the invention. The body 1 comprises a peripheral flange 11 along its lower edge. The base 2 comprises a peripheral flange 21 along its upper edge. The fastening device 3 is shaped like a closed loop with a substantially T-shaped cross-section (see FIG. 2). The fastening device 3 comprises a peripheral groove 32 along its upper edge and a peripheral groove 31 along its lower edge.

Referring to FIG. 4 specifically, in assembly first align the base 2 with the fastening device 3 and the body 1, i.e., align the peripheral flange 11 with the upper peripheral groove 32 and the peripheral flange 21 with the lower peripheral groove 31 respectively. Then drive a plurality of fasteners (e.g., screws) 4 through threaded holes in the base 2, the fastening device 3, and the body 1 to secure them together, i.e., in a direction from bottom to top of the cellular phone.

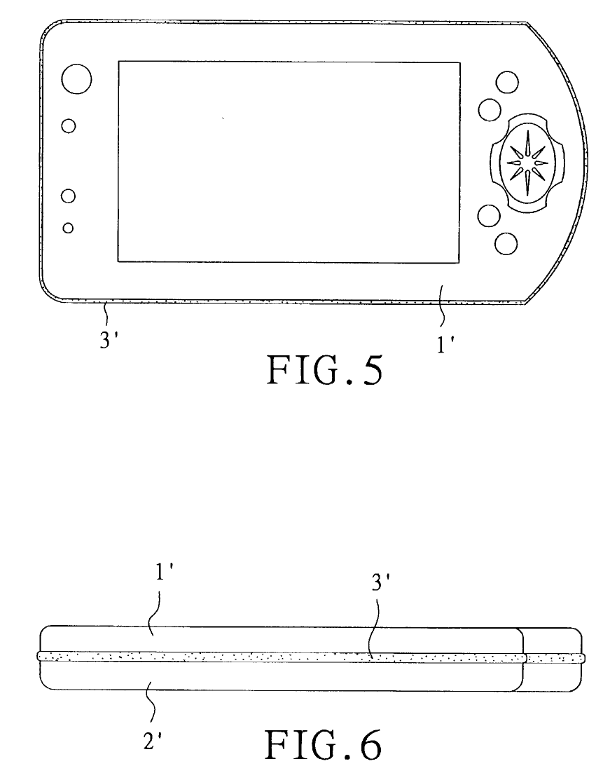

Referring to FIGS. 5 and 6, in another embodiment of the invention a PDA is the subject wherein body 1′ of the PDA is secured to base 2′ thereof by a fastening device 3′ the same as the fastening device 3.

Note that the fastening device may have a shape other than that shown above. Further for aesthetic purpose, color of the fastening device may vary for being adapted to that of cellular phone or PDA.

While the invention has been described by means of specific embodiments, numerous modifications and variations could be made thereto by those skilled in the art without departing from the scope and spirit of the invention set forth in the claims.

What is claimed is:

1. An intermediate arrangement for fastening a body of a portable communication device to its base wherein the body includes a lower peripheral flange, the base includes an upper peripheral flange, the arrangement is shaped like a closed loop with a substantially T-shaped cross-section, the arrangement comprising an upper peripheral groove and a lower peripheral groove wherein the lower peripheral flange is aligned with the upper peripheral groove and the upper peripheral flange is aligned with the lower peripheral groove respectively prior to threadedly securing the base, the arrangement, and the body together.

2. The arrangement of claim 1, wherein the portable communication device is a cellular phone.

3. The arrangement of claim 1, wherein the portable communication device is a PDA.
